(19) United States
(12) Patent Application Publication
(10) Pub. No.: US 2012/0223977 A1
(43) Pub. Date: Sep. 6, 2012

(54) DISPLAY CONTROLLING APPARATUS, DISPLAY CONTROLLING METHOD, AND PROGRAM

(75) Inventors: Tetsuji Inada, Kanagawa (JP); Mitsuyasu Asano, Tokyo (JP)

(73) Assignee: SONY CORPORATION, Tokyo (JP)

(21) Appl. No.: 13/400,855

(22) Filed: Feb. 21, 2012

(30) Foreign Application Priority Data
Mar. 4, 2011 (JP) P2011-047889

(51) Int. Cl. G09G 5/10

(52) U.S. Cl. 345/690

(57) ABSTRACT

Disclosed herein is a display controlling apparatus, including a light source controlling section adapted to generate a light emitting signal which defines a luminance of a light source based on an input image signal representative of an image and transmit the generated light emission signal to the light source; a gradation conversion section adapted to convert a gradation of the input image signal; and a transmission factor controlling section adapted to generate, based on the light emission signal and a conversion image signal which is an image signal having a gradation converted from that of the input image signal, a transmission controlling signal which defines a transmission factor of light emitted from the light source through a display panel and transmit the generated transmission controlling signal to the display panel.

### CROSS-REFERENCE TO RELATED APPLICATION

The present application claims priority from Japanese Patent Application No. JP 2011-047889 filed in the Japanese Patent Office on Mar. 4, 2011, the entire content of which is incorporated herein by reference.

### BACKGROUND

The present disclosure disclosed herein relates to a display controlling apparatus, a display controlling method, and a program.

In recent years, various display apparatus such as a liquid crystal display (LCD) apparatus, an organic EL display (Organic Electroluminescence display, also called OLED display (Organic Light Emitting Diode display)) apparatus, a field emission display (FED) apparatus and a plasma display (PDP: Plasma Display Panel) apparatus have been developed as display apparatus which replace a CRT display (Cathode Ray Tube display) apparatus. Of such various display apparatus as described above, the liquid crystal display apparatus has popularized in an accelerating manner as a display apparatus which replaces the CRT display apparatus, for example, because it can be driven with low power consumption and the production technology therefor has matured to achieve reduction of the cost. The liquid crystal display apparatus is used as a display device which is provided in various kinds of equipment such as, for example, a portable communication apparatus such as a portable telephone set and a computer such as a PC (Personal Computer). The liquid crystal display apparatus is a display apparatus which includes a liquid crystal panel or the like which includes, for example, a light source such as, for example, a backlight, a polarizing plate for inputting light emitted from the light source to the liquid crystal display panel and a liquid crystal shutter for transmitting the light emitted from the light source therethrough with a variable transmission factor.

A technique for achieving high picture quality of an image to be displayed on the display screen of a display apparatus having a separate light source has been and is being developed. A technique of controlling the luminance of a light source and the transmission factor of light emitted from the light source through a display panel to achieve high picture quality is disclosed, for example, in Japanese Patent Laid-Open No. 2009-267475.

### SUMMARY

In such a technique for achieving high picture quality as disclosed in the document mentioned above, the luminance of the light source is controlled based on an image signal representative of an image such as a moving image or a still image. Then, the transmission factor of light to be emitted from the light source through the display panel is controlled based on a result of adjustment of the light source and the image signal. Therefore, where the technique described is applied, there is the possibility that high picture quality of an image to be displayed on the display screen of the display panel may be achieved.

However, even if the technique is applied, for example, in such a case that an image represented by the image signal does not have a sufficient gradation, there is the possibility that the gradation representation through the control of the luminance of the light source cannot be sufficiently utilized.

Therefore, it is desirable to provide a display controlling apparatus, a display controlling method, and a program which are novel and improved in that a display apparatus having a separate light source can achieve high picture quality.

According to a mode of the present disclosure disclosed herein, there is provided a display controlling apparatus including a light source controlling section adapted to generate a light emitting signal which defines a luminance of a light source based on an input image signal representative of an image and transmit the generated light emission signal to the light source, a gradation conversion section adapted to convert a gradation of the input image signal, and a transmission factor controlling section adapted to generate, based on the light emission signal and a conversion image signal which is an image signal having a gradation converted from that of the input image signal, a transmission controlling signal which defines a transmission factor of light emitted from the light source through a display panel and transmit the generated transmission controlling signal to the display panel.

With the display controlling apparatus, high picture quality of an image to be displayed on the display screen of the display apparatus having a separate light source can be achieved.

The display controlling apparatus may further include a decision section adapted to decide based on the input image signal whether or not the gradation of the input image signal should be converted. The decision section transmits, when the decision section decides that the gradation of the input image signal should be converted, the input image signal to the gradation conversion section whereas, when the decision section does not decide that the gradation of the input image signal should be converted, the decision section transmits the input image signal to the transmission factor controlling section. The transmission factor controlling section generates the transmission controlling signal based on the light emission signal and one of the input image signal and the conversion image signal.

Or, the display controlling apparatus may further include a light source adapted to emit light in response to the light emission signal transmitted thereto, and a display panel adapted to adjust the transmission factor in response to the transmission controlling signal to be transmitted to display an image on a display screen thereof.

According to another mode of the present disclosure disclosed herein, there is provided a display controlling method including generating a light emitting signal which defines a luminance of a light source based on an input image signal representative of an image and transmitting the generated light emission signal to the light source, converting a gradation of the input image signal, and generating, based on the light emission signal and a conversion image signal which is an image signal having a gradation converted from that of the input image signal, a transmission controlling signal which defines a transmission factor of light emitted from the light source through a display panel and transmitting the generated transmission controlling signal to the display panel.

With the display controlling method, high picture quality of an image to be displayed on the display screen of the display apparatus having a separate light source can be achieved.

According to a further mode of the present disclosure disclosed herein, there is provided a program for causing a computer to function as a light source controller generating a light emitting signal which defines a luminance of a light source based on an input image signal representative of an image and transmitting the generated light emission signal to the light source, a gradation converter converting a gradation of the input image signal, and a transmission factor controller generating, based on the light emission signal and a conversion image signal which is an image signal having a gradation converted from that of the input image signal, a transmission controlling signal which defines a transmission factor of light emitted from the light source through a display panel and transmitting the generated transmission controlling signal to the display panel.

With the program, high picture quality of an image to be displayed on the display screen of the display apparatus having a separate light source can be achieved.

In summary, with the present disclosure, high picture quality of an image to be displayed on the display screen of the display apparatus having a separate light source can be achieved.

The above and other objects, features and advantages of the present disclosure will become apparent from the following description and the appended claims, taken in conjunction with the accompanying drawings in which like parts or elements denoted by like reference symbols.

### BRIEF DESCRIPTION OF THE DRAWINGS

FIGS. 1 and 2 are diagrammatic views illustrating a display controlling method to which embodiments of the present disclosure is applied;

FIG. 3 is a block diagram showing an example of a configuration of a display controlling apparatus according to a first embodiment of the present disclosure; and

FIG. 4 is a block diagram showing an example of a configuration of a display controlling apparatus according to a second embodiment of the present disclosure.

### DETAILED DESCRIPTION OF THE PREFERRED EMBODIMENTS

In the following, preferred embodiments of the present disclosure are described in detail with reference to the accompanying drawings.

The description is given in the following order:
1. Display Controlling Method to Which the Present Disclosure Is Applied
2. Display Controlling Apparatus to Which the Present Disclosure Is Applied
3. Program to Which the Present Disclosure Is Applied
   1. Display Controlling Method to which the Present Disclosure is Applied

Before a configuration of a display controlling apparatus 100 to which the present disclosure is applied, an outline of a display controlling method to which the present disclosure is applied is described. In the following description, it is assumed that the display controlling apparatus 100 carries out processing of the display controlling method according to the embodiment.

Further, in the description of the display controlling method, it is assumed that the display controlling apparatus 100 includes a light source, and a display panel which transmits light emitted from the light source therethrough to display an image on a display screen. In other words, it is assumed that the display controlling apparatus 100 functions as a display apparatus having a separate light source. In this instance, the object of control of the display controlling apparatus 100 is, for example, the light source and the display panel provided in the display controlling apparatus 100. It is to be noted that the controlling object of the display controlling apparatus 100 according to the embodiment is not limited to the light source and the display panel provided in the display controlling apparatus 100. For example, in the display controlling apparatus 100, an external display apparatus which includes a light source and a display panel can be used as the controlling object irrespective of whether the display controlling apparatus 100 includes the light source and the display panel.

The display controlling apparatus 100 to which the present disclosure is applied controls the luminance of the light source and the transmission factor of light emitted from the light source through the display panel. In the case where the luminance of the light source and the transmission factor of light emitted from the light source through the display panel are controlled, the display on the display screen depends upon the luminance of the light source and the transmission factor of light emitted from the light source through the display panel (hereinafter referred to sometimes as “transmission factor through the display panel”) as represented by Expression 1 given below. Further, the transmission factor through the display panel is calculated, for example, in accordance with Expression 2 given below.

Display on display screen=(luminance of light source)×(transmission factor through display panel) (Expression 1)

Transmission factor through display panel=(signal value of image signal)/(luminance of light source) (Expression 2)

The signal value of the image signal represented by Expression 2 may be, for example, a luminance value. Meanwhile, the transmission factor through the display panel may be, for example, a transmission factor for each pixel, a transmission factor for each pixel region including a plurality of pixels or a transmission factor corresponding to the overall display screen. Further, the luminance of the light source may be, for example, a luminance over the overall display screen or a luminance for each pixel region including one, two or more pixels.

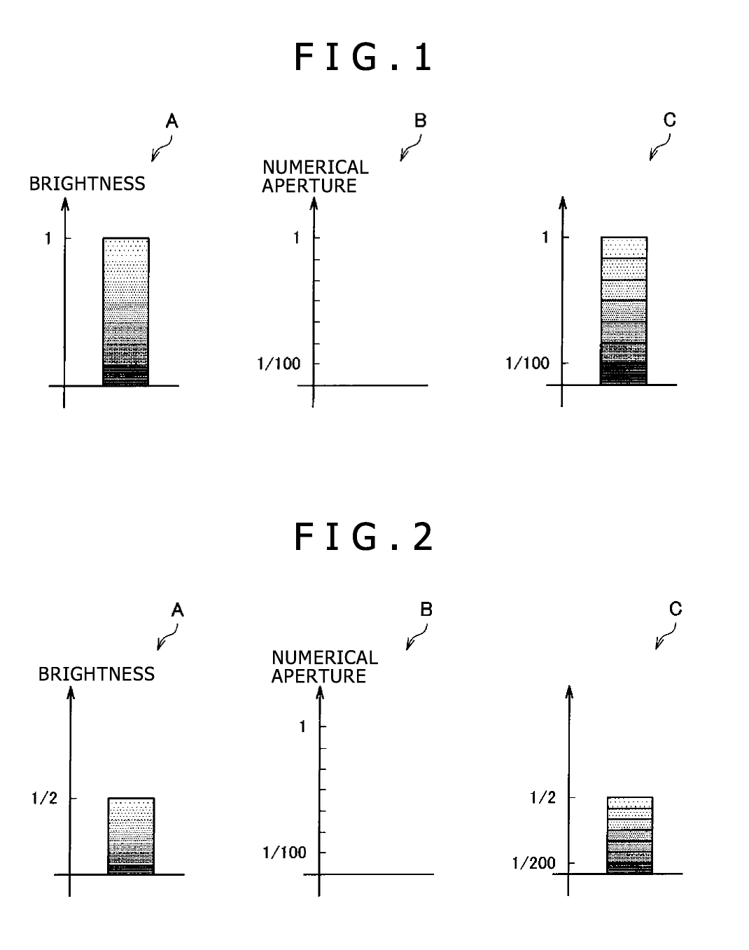

FIGS. 1 and 2 illustrate the display controlling method to which the present disclosure is applied. In particular, each of A of FIGS. 1 and A of FIG. 2 illustrates a luminance or brightness of the light source represented by 1 to 1/100. Meanwhile, each of B of FIGS. 1 and B of FIG. 2 illustrates a numerical aperture of the display panel. Further, each of C of FIGS. 1 and C of FIG. 2 illustrates gradations which can be represented on the display screen in the case of A and B of FIGS. 1 and 2.

In the case where the luminance of the light source is represented by 1 to 1/100 as seen in FIG. 1, it is possible to display gradations of 1 to 1/100 on the display screen. On the other hand, if the luminance of the light source is reduced to ½ from that illustrated in FIG. 1 as seen in FIG. 2, then if the numerical aperture of the display panel is equal, then the display screen can represent gradations of ½ to 1/200, or in other words, can represent finer gradations.

However, if an image represented by an image signal corresponding to the image to be displayed on the display screen (such image signal is sometimes referred to as “input image signal”) does not have a sufficient gradation, then the gradation representation when the luminance of the light source is controlled cannot be sufficiently utilized as seen in FIGS. 1 and 2.

More particularly, for example, when an image corresponding to an input image signal of a gradation representation of 1/100 is to be displayed on the display screen, even if the luminance of the light source is reduced to ½ as seen in FIG. 2, the transmission factor through the display panel becomes “ 1/100÷½= 1/50.” Therefore, since the display on the display screen in the case described above becomes 1/100 from Expression 1 given above, when the luminance of the light source reduces to ½ as seen in FIG. 2, the gradation which can be represented cannot be sufficiently utilized.

Therefore, the display controlling apparatus 100 to which the present disclosure is applied carries out a gradation conversion process of creating a gradation of an input image signal such as, for example, a process of increasing a gradation, and controls the transmission factor through the display panel based on an image signal obtained by the gradation conversion. Such an image signal is hereinafter referred to as “conversion image signal.” Here, since the transmission factor through the display panel is calculated, for example, in accordance with Expression 2 given hereinabove, by converting the gradation of the input image signal as described above, the transmission factor though the display panel is improved in comparison with the alternative case in which such gradation conversion is not carried out. Therefore, even if an image represented by the input image signal does not have a sufficient gradation, the display controlling apparatus 100 can sufficiently make use of the gradation representation by controlling the luminance of the light source.

Accordingly, the display controlling apparatus 100 can achieve high picture quality of an image displayed on the display screen of a display apparatus which has a separate light source.

In the following, an example of a configuration of the display controlling apparatus 100 to which the present disclosure is applied is described, and also a particular example of processing according to the display controlling method to which the present disclosure is applied is described.

2. Display Controlling Apparatus to which the Present Disclosure is Applied

### Display Controlling Apparatus According to the First Embodiment

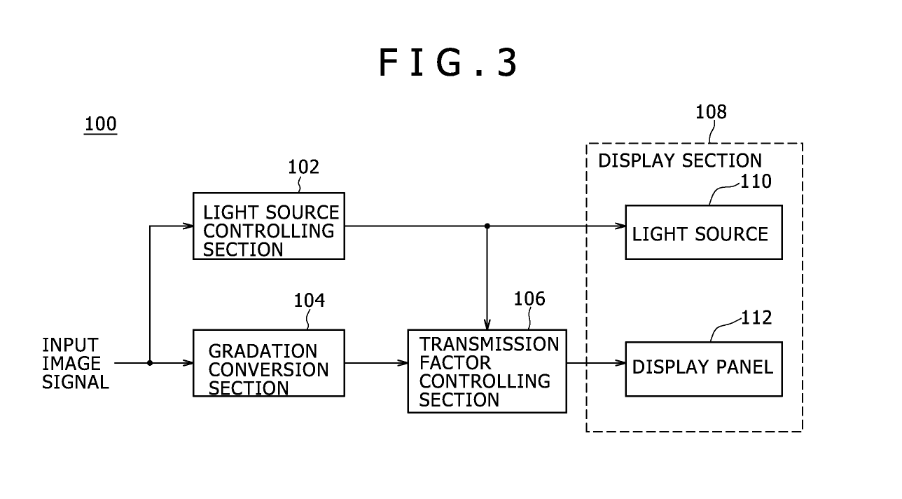

FIG. 3 shows an example of a configuration of the display controlling apparatus 100 according to a first embodiment of the present disclosure. FIG. 3 particularly shows an example of a configuration in the case where the display controlling apparatus 100 functions as a display apparatus.

Referring to FIG. 3, the display controlling apparatus 100 includes, for example, a light source controlling section 102, a gradation conversion section 104, a transmission factor controlling section 106 and a display section 108.

The display controlling apparatus 100 may further include, for example, a control section not shown, a ROM (Read Only Memory) not shown, a RAM (Random Access Memory) not shown, a storage section not shown, an operation section not shown which can be operated by a user, and a communication section not shown for communicating with an external apparatus. The components mentioned of the display controlling apparatus 100 are connected to each other, for example, by a bus as a transmission line for data.

The control section not shown may be configured, for example, from an MPU (Micro Process Unit), various processing circuits and so forth and controls the entire display controlling apparatus 100. Further, the control section not shown may play roles, for example, of the light source controlling section 102, gradation conversion section 104 and transmission factor controlling section 106.

The ROM not shown stores programs and controlling parameters such as arithmetic operation parameters which are used by the control section not shown. The RAM not shown temporarily stores a program to be executed by the control section not shown or the like.

The storage section not shown is a storage block provided in the display controlling apparatus 100 and stores various data such as, for example, image data and applications. The storage section not shown may be, for example, a magnetic recording medium such as a hard disk, a nonvolatile memory such as an EEPROM (Electrically Erasable and Programmable Read Only Memory) or a flash memory.

The operation section not shown may be, for example, buttons, direction keys, a rotational type selector such as a jog dial or a combination of them. Further, it is possible to connect the display controlling apparatus 100 to an operation inputting device such as, for example, a keyboard or a mouse as an external apparatus of the display controlling apparatus 100.

The communication section not shown is a communication block provided in the display controlling apparatus 100 and communicates with an external apparatus through a network or directly by wire or wireless communication. The communication section not shown may be a communication antenna and a RF (Radio Frequency) circuit (wireless communication), an IEEE802.15.1 port and a transmission and reception circuit (wireless communication), an IEEE802.11b port and a transmission and reception circuit (wireless communication), a LAN (Local Area Network) terminal and a transmission and reception circuit (wire communication) or the like. Further, the network may be a wire network such as, for example, a LAN or a WAN (Wide Area Network), a wireless network such as a wireless WAN (WWAN: Wireless Wide Area Network) through a base state, the Internet in which a communication protocol such as TCP/IP (Transmission Control Protocol/Internet Protocol) is used, or the like.

In the following, the configuration example of the display controlling apparatus 100 according to the first embodiment shown in FIG. 3 and an example of processing by the display controlling apparatus 100 relating to the display controlling method are described.

The light source controlling section 102 generates a light emission signal which defines a luminance of a light source based on an input image signal. Then, the light source controlling section 102 transmits the generated light emission signal to the transmission factor controlling section 106 and a light source 110 which configures the display section 108.

The input image signal here may be, for example, an image signal obtained by reception of a broadcasting wave transmitted from a television tower by the display controlling apparatus 100 directly or indirectly through a set top box or the like. However, the input image signal to be applied in the present embodiment is not limited to the image signal just described. For example, the display controlling apparatus 100 may process an image signal transmitted from an external apparatus through a network or directly as an input image signal. Or the display controlling apparatus 100 may process an image obtained, for example, by decoding image data stored in the storage section hereinafter described or stored in a removable external recording medium from the display controlling apparatus 100 as an input image signal.

More particularly, the light source controlling section 102 determines a maximum value of the luminance of a pixel in the case where an image is displayed on the display screen of a display panel 112, for example, based on the input image signal. Then, the light source controlling section 102 generates a light emission signal corresponding to the maximum value of the luminance determined based on the input image signal.

Although the light source controlling section 102 takes, for example, the entire display screen of the display panel 112 which configures the display section 108 as one region and generates a light emission signal corresponding to the entire display screen, the processing of the light source controlling section 102 is not limited to that described above. For example, if the light source 110 has a configuration which can irradiate light independently upon each of a plurality of divisional regions into which the display screen of the display panel 112 is divided, then the light source controlling section 102 can generate a light emission signal for each of the divisional regions. Therefore, the light source controlling section 102 is configured from a processing circuit for generating, for example, one, two or more light emission signals corresponding to the configuration of the light source 110.

It is to be noted that the light source controlling section 102 in the present embodiment is not limited to the configuration which generates a light emission signal corresponding to a maximum value of the luminance determined based on an input image signal. For example, the light source controlling section 102 may otherwise correct a light emission signal corresponding to a current frame based on the difference between a light emission signal corresponding to the immediately preceding frame and another light emission signal which corresponds to the current frame and transmit the corrected light emission signal to the transmission factor controlling section 106 and the light source 110.

The gradation conversion section 104 creates, for example, a gradation of an input image signal to convert the gradation of the input image signal. Then, the gradation conversion section 104 transmits the image signal having a gradation obtained by the conversion of the gradation of the input image signal to the transmission factor controlling section 106. It is to be noted that the signal having a gradation obtained by the gradation conversion is hereinafter referred to sometimes as “conversion image signal.”

The gradation conversion section 104 has a configuration for a technique for carrying out A modulation such as, for example, a technique disclosed in Japanese Patent Laid-Open No. 2010-87977 or a technique disclosed in Japanese Patent Laid-Open No. 2010-108064 such that the gradation of the input image signal is converted. It is to be noted that the gradation conversion section 104 is not limited to the configuration which uses a technique for carrying out A conversion to convert the gradation of the input image signal. For example, the gradation conversion section 104 may be configured such that it uses an arbitrary technique which can create a gradation of the input image signal to convert the gradation of the input image signal.

The transmission factor controlling section 106 generates a transmission controlling signal which defines the transmission factor of light emitted from the light source through the display panel based on the light emission signal transmitted thereto from the light source controlling section 102 and the conversion image signal transmitted thereto from the gradation conversion section 104. More particularly, the transmission factor controlling section 106 is configured, for example, from a divider and carries out an arithmetic operation represented by Expression 2 given hereinabove to generate a transmission controlling signal. Then, the transmission factor controlling section 106 transmits the generated transmission controlling signal to the display panel 112.

Here, the transmission factor controlling section 106 takes, for example, the entire display screen of the display panel 112 as one region and generates a transmission communication signal corresponding to the entire display screen. However, the processing in the transmission factor controlling section 106 is not limited to that just described. For example, if the light source 110 has a configuration which can irradiate light independently upon each of a plurality of divisional regions into which the display screen of the display panel 112 is divided, then the display controlling apparatus 100 can be configured so that the light source controlling section 102 generates a light emission signal for each of the divisional regions. In the case just described, the transmission factor controlling section 106 may include, for example, one, two or more dividers or the like corresponding to light emission signals for the divisional regions transmitted from the light source controlling section 102. In the case where the transmission factor controlling section 106 has the configuration just described, the transmission factor controlling section 106 can generate a transmission controlling signal corresponding to each of the light emission signals for the divisional regions transmitted from the light source controlling section 102.

The display section 108 is a display block provided in the display controlling apparatus 100. The display section 108 includes a light source 110 and a display panel 112. Though not shown in FIG. 3, the display section 108 may include, for example, various drivers not shown for causing the display panel 112 to display an image such as, for example, a scanning driver, a data driver and a common driver, and a display controlling section not shown for driving the drivers based on a transmission controlling signal transmitted thereto. The display controlling section not shown may be any of various processing circuits such as, for example, an MPU or a timing controller. It is to be noted that the display panel 112 in the present embodiment can naturally have a configuration which has the drivers and the display controlling section not shown described above.

The display controlling apparatus 100 in the first embodiment has, for example, such a configuration as shown in FIG. 3 and carries out (A) a process of generating a light emission signal based on an input image signal and transmitting the generated light emission signal to the light source, (B) a process of converting the gradation of the input image signal and (C) a process of generating a transmission controlling signal based on the light emission signal and the conversion image signal and transmitting the generated transmission controlling signal to the display panel. By carrying out the processes of (A) to (C), the display controlling apparatus 100 implements control of the luminance of the light source 110 based on an input image signal and control of the transmission factor of light to be emitted from the light source 110 through the display panel 112 based on an image signal, that is, a conversion image signal, obtained by conversion of the luminance of the input image signal. In other words, the processes of (A) to (C) correspond to processes by the display controlling method to which the present disclosure is applied. Therefore, the display controlling apparatus 100 can execute the display controlling method to which the present disclosure is applied as described above, for example, by the configuration shown in FIG. 3.

Accordingly, the display controlling apparatus 100 according to the first embodiment can achieve high quality of an image to be displayed on the display screen of a display apparatus having a separate light source (in the example of FIG. 3, on the display screen of the display panel 112 which configures the display section 108).

It is to be noted that the configuration of the display controlling apparatus 100 to which the present disclosure is applied is not limited to the configuration shown in FIG. 3. For example, the display controlling apparatus 100 to which the present disclosure is applied can selectively carry out the process of (B) according to the display controlling method of the present embodiment, that is, the process of converting the gradation of an input image signal, in response to the input image signal. Therefore, as a display controlling apparatus according to a second embodiment (such apparatus is hereinafter referred to sometimes as “display controlling apparatus 200”), an example of a configuration of a display controlling apparatus which can selectively carry out the process of (B) of the display controlling method is described.

### 2. Display Controlling Apparatus According to the Second Embodiment

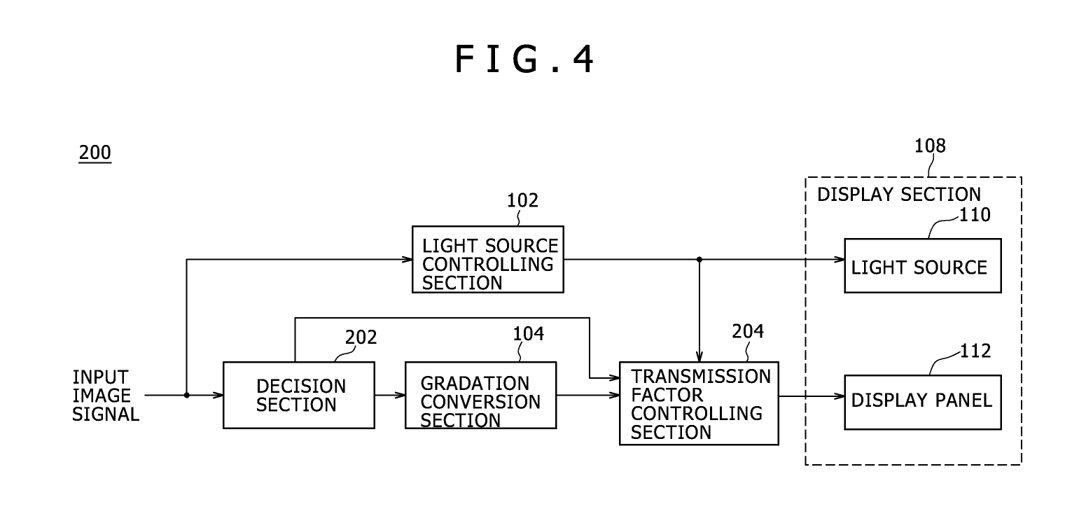

FIG. 4 shows an example of a configuration of the display controlling apparatus 200 according to the second embodiment. FIG. 4 particularly shows a configuration in the case where the display controlling apparatus 200 functions as a display apparatus, similarly to the display controlling apparatus 100 shown in FIG. 3 according to the first embodiment.

Referring to FIG. 4, the display controlling apparatus 200 according to the second embodiment has a configuration basically same as that of the display controlling apparatus 100 according to the first embodiment. However, the display controlling apparatus 200 additionally includes, in comparison with the display controlling apparatus 100, a decision section 202 provided at the preceding stage to the gradation conversion section 104. Further, in the display controlling apparatus 200, processing of a transmission factor controlling section 204 is different from the processing of the transmission factor controlling section 106 in the first embodiment shown in FIG. 3.

The decision section 202 decides based on an input image signal whether or not the gradation of the input image signal should be converted. Here, the decision section 202 carries out the decision regarding whether or not the gradation of the input image signal should be converted, for example, based on the bit number of the input image signal and a predetermined bit number, that is, a threshold value, such as 8 bits. More particularly, for example, when the bit number of the input image signal is smaller than the predetermined bit number, the decision section 202 decides that the gradation of the input image signal should be converted, but in any other case, the decision section 202 decides that the gradation of the input image signal should not be converted.

It is to be noted that the decision method by the decision section 202 in the present embodiment is not limited to a decision method based on the bit number of the input image signal. For example, the decision section 202 may detect a flat region, in which, for example, the difference value between adjacent pixels is lower than a predetermined value, based on an input image signal and selectively decide to convert the gradation of the input image signal corresponding to the detected region. If the decision method just described is used, then the decision section 202 can carry out the decision, for example, for each of such divisional regions as described above.

Here, while the decision section 202 can be implemented from a processing circuit for exclusive use having an arbitrary configuration for implementing such a decision method as described above, the display controlling apparatus 200 according to the second embodiment is not limited to a configuration which includes the decision section 202 which is implemented by a processing circuit for exclusive use. For example, in the display controlling apparatus 200 according to the second embodiment, the control section not shown may play the role of the decision section 202.

If the decision section 202 decides that the gradation of the input image signal should be converted, then it transmits the input image signal to the gradation conversion section 104. Therefore, the gradation of the input image signal is converted by the gradation conversion section 104, and a resulting conversion image signal is transmitted to the transmission factor controlling section 204.

On the other hand, if the decision section 202 does not decide that the gradation of the input image signal should be converted, then it transmits the input image signal to the transmission factor controlling section 204. In this instance, since the input image signal is not transmitted to the gradation conversion section 104, the display controlling apparatus 200 does not carry out the process of (B) of the display controlling method according to the present embodiment, that is, the process of converting the gradation of the input image signal.

Therefore, by the provision of the decision section 202, the display controlling apparatus 200 can selectively carry out the process of (B) of the display controlling method according to the present embodiment based on the input image signal.

The transmission factor controlling section 204 generates a transmission control signal based on the light emission signal transmitted thereto from the light source controlling section 102 and one of the input image signal transmitted thereto from the decision section 202 and the conversion image signal transmitted thereto from the gradation conversion section 104 similarly to the transmission factor controlling section 106 according to the first embodiment described hereinabove with reference to FIG. 3. Then, the transmission factor controlling section 204 transmits the generated transmission control signal to the display panel 112 or to the above-described display controlling section not shown.

The display controlling apparatus 200 according to the second embodiment has a configuration basically similar to that of the display controlling apparatus 100 according to the first embodiment shown in FIG. 3. Therefore, the display controlling apparatus 200 can carry out, by the configuration shown in FIG. 4, the processes of (A) to (C) described hereinabove of the display controlling method to which the present disclosure is applied. Accordingly, the display controlling apparatus 200 can exhibit effects similar to those exhibited by the display controlling apparatus 100 according to the first embodiment shown in FIG. 3.

Further, the display controlling apparatus 200 includes the decision section 202 and selectively carries out the process of (B) of the display controlling method according to which the present disclosure is applied in response to the input image signal. Here, for example, in a case where the bit number of the input image signal is not lower than the predetermined bit number or the input image signal is not an image signal which indicates a flat region, even if the process of the display controlling method to which the present disclosure is applied is not carried out, deterioration of the picture quality arising from the fact that the gradation representation described hereinabove cannot be sufficiently utilized. Further, by selectively carrying out the process of (B) described hereinabove of the display controlling method to which the present disclosure is applied in response to a result of the decision of the decision section 202, it is possible to reduce the power required for the process of (B), that is, the power consumed by the gradation conversion section 104. Accordingly, by the provision of the decision section 202, the display controlling apparatus 200 can achieve reduction of the power consumption while preventing deterioration of the picture quality from arising from the fact that the gradation representation described hereinabove cannot be sufficiently utilized.

### Modifications to the Display Controlling Apparatus According to the First and Second Embodiments

It is to be noted that the configuration of the display controlling apparatus 100 to which the present disclosure is applied is not limited to the configuration shown in FIG. 3 or 4. For example, while the display controlling apparatus 100 in FIGS. 3 and 4 includes the display section 108 and functions as a display apparatus, it may not include the display section 108. In this instance, the display controlling apparatus 100 controls display of the external display apparatus connected, for example, by wire or wireless connection thereto by transmitting a light emission signal and a transmission controlling signal to the external display apparatus.

Here, a display controlling apparatus 100 according to a modification may transmit the light emission signal and the transmission controlling signal to the external display apparatus, for example, through a communication section not shown or through an input/output interface. The input/output interface may be, for example, a USB (Universal Serial Bus) terminal, a DVI (Digital Visual Interface) terminal, an HDMI (High-Definition Multimedia Interface) terminal or a suitable processing circuit.

As described above, the display controlling apparatus 100 to which the present disclosure is applied generates a transmission controlling signal based on the process of (A), that is, the process of generating a light emission signal based on an input image signal and transmitting the generated light emission signal to the light source, the process of (B), that is, the process of converting the gradation of the input image signal, and the process of (C), that is, the process of generating a transmission controlling signal based on the light emission signal and the conversion image signal and transmitting the generated transmission controlling signal to the display panel, to control the luminance of the light source and the transmission factor of light to be emitted from the light source through the display panel. Here, since the transmission factor through the display panel is calculated, for example, in accordance with Expression 2 given hereinabove, by converting the gradation of the input image signal by the process of (B), the transmission factor through the display panel is improved in comparison with an alternative case wherein such conversion of the gradation is not carried out. Therefore, even in the case where an image represented by the input image signal does not have a sufficient gradation, the display controlling apparatus 100 can sufficiently make use of the gradation representation by the control of the luminance of the light source.

Accordingly, the display controlling apparatus 100 can achieve high picture quality of an image displayed on the display screen of a display apparatus which has a separate right source.

Further, the display controlling apparatus 100 can be configured such that the process of (B) is selectively carried out in response to the input image signal. In this instance, the display controlling apparatus 100 corresponds to the display controlling apparatus 200 according to the second embodiment. Where the configuration described above is adopted, the display controlling apparatus 100 can achieve further reduction of the power consumption.

While the present disclosure has been described in detail in connection with the display controlling apparatus 100 according to the embodiment thereof, it can be carried out also in other various modified forms. The present disclosure can be applied to various apparatus which include a display apparatus which in turn includes a light source and a display panel having a variable transmission factor such as, for example, a computer such as a PC, a portable communication apparatus such as a portable telephone set, a video/music reproduction apparatus, a portable game machine and a liquid crystal television receiver. Further, the present disclosure can be applied to various apparatus which can control display of equipment including, for example, such a display apparatus as described above, from the outside, that is, equipment which functions as a control apparatus. Further, the present disclosure can be applied also to a controlling IC (Integrated Circuit) which can be incorporated, for example, in equipment which includes such a display apparatus as described above or equipment which functions as a control apparatus.

### 3. Program According to the Embodiment of the Present Disclosure

A program for causing a computer to function as the display controlling apparatus according to the embodiment of the present disclosure, that is, a program for implementing the process according to the display controlling method according to the embodiment of the present disclosure such as a program for implementing the processes of (A) to (C) described hereinabove, can achieve improvement in picture quality of an image to be displayed on the display screen of a display apparatus which has a separate light source.

While preferred embodiments of the present disclosure have been described above with reference to the accompanying drawings, naturally the present disclosure is not limited to the embodiments. It is apparent that a person skilled in the art could have made various alterations or modifications without departing from the spirit and scope of the present disclosure as defined in claims, and it is understood that also such alterations and modifications naturally fall within the technical scope of the present disclosure.

For example, although it is described above that a program, that is, a computer program, for causing a computer to function as a display controlling apparatus according to the embodiment of the present disclosure is provided by the present disclosure, the present disclosure can provide also a recording medium on or in which the program is stored.

Also the configuration just described demonstrates an example of an embodiment of the present disclosure and is naturally embraced in the technical scope of the present disclosure.

It should be understood by those skilled in the art that various modifications, combinations, sub-combinations and alterations may occur depending on design requirements and other factors in so far as they are within the scope of the appended claims or the equivalents thereof.

What is claimed is:

1. A display controlling apparatus, comprising:
a light source controlling section adapted to generate a light emitting signal which defines a luminance of a light source based on an input image signal representative of an image and transmit the generated light emission signal to the light source;
a gradation conversion section adapted to convert a gradation of the input image signal; and
a transmission factor controlling section adapted to generate, based on the light emission signal and a conversion image signal which is an image signal having a gradation converted from that of the input image signal, a transmission controlling signal which defines a transmission factor of light emitted from the light source through a display panel and transmit the generated transmission controlling signal to the display panel.

2. The display controlling apparatus according to claim 1, further comprising:
a decision section adapted to decide based on the input image signal whether or not the gradation of the input image signal should be converted; wherein
said decision section transmits, when said decision section decides that the gradation of the input image signal should be converted, the input image signal to said gradation conversion section whereas, when said decision section does not decide that the gradation of the input image signal should be converted, said decision section transmits the input image signal to said transmission factor controlling section, and
said transmission factor controlling section generates the transmission controlling signal based on the light emission signal and one of the input image signal and the conversion image signal.

3. The display controlling apparatus according to claim 1, further comprising:
a light source adapted to emit light in response to the light emission signal transmitted thereto; and
a display panel adapted to adjust the transmission factor in response to the transmission controlling signal to be transmitted to display an image on a display screen thereof.

4. A display controlling method, comprising:
generating a light emitting signal which defines a luminance of a light source based on an input image signal representative of an image and transmitting the generated light emission signal to the light source;
converting a gradation of the input image signal; and
generating, based on the light emission signal and a conversion image signal which is an image signal having a gradation converted from that of the input image signal, a transmission controlling signal which defines a transmission factor of light emitted from the light source through a display panel and transmitting the generated transmission controlling signal to the display panel.

5. A program causing a computer to function as:
a light source controller generating a light emitting signal which defines a luminance of a light source based on an input image signal representative of an image and transmitting the generated light emission signal to the light source;
a gradation converter converting a gradation of the input image signal; and
a transmission factor controller generating, based on the light emission signal and a conversion image signal which is an image signal having a gradation converted from that of the input image signal, a transmission controlling signal which defines a transmission factor of light emitted from the light source through a display panel and transmitting the generated transmission controlling signal to the display panel.
